(19) United States
(12) Patent Application Publication
(10) Pub. No.: US 2024/0203299 A1
(43) Pub. Date: Jun. 20, 2024

(54) MANUAL MECHANICAL PRICER

(71) Applicant: PRODUCCIONES SIGNALÉTICAS MEXICANAS, S.A. DE C.V., MEXICO CITY (MX)

(72) Inventors: Armando Jaime BECERRA SUÁREZ, MORELIA (MX); Alexis RODRÍGUEZ PALOMEQUE, NEZAHUALCÓYOTL (MX); Alejandra Paulina ENRÍQUEZ PACHECO, ZUMPANGO (MX); Marcos CÓRDOVA MENDOZA, CIUDAD DE MEXICO (MX)

(73) Assignee: PRODUCCIONES SIGNALÉTICAS MEXICANAS, S.A. DE C.V., MEXICO CITY (MX)

(21) Appl. No.: 18/542,876

(22) Filed: Dec. 18, 2023

(30) Foreign Application Priority Data
Dec. 16, 2022 (MX) MX/A/2022/016605

(51) Int. Cl. G09F 11/02

(52) U.S. Cl. CPC G09F 11/02; G09F 2011/0036

(57) ABSTRACT

The present invention provides a manual mechanical pricer, having a pulley mechanism with a plurality of bands printed with numbers, which are used to represent the price of traded items, said pulley mechanism being covered by a protective cover that protects it from impact damage and at the same time prevent unauthorized tampering.

### FIELD OF INVENTION

The present invention relates to a manual mechanical pricer and, more particularly, it relates to a pricer device with an independent pulley mechanism for selecting the numbers with which the prices are displayed, said pulley mechanism being protected by a cover collapsible with an automatic closing mechanism, which protects the pulley mechanism from dust and dirt that can accumulate and cause malfunction of the pulley mechanism, as well as damage caused by collisions with objects. Likewise, the manual mechanical pricer of the present invention comprises an opening security mechanism that prevents unauthorized manipulation of the pulley mechanism.

### BACKGROUND OF THE INVENTION

The constant change in product prices, either by competitive strategies, by increases due to inflation, by changes in regulations, by corporate policies, among others, has caused commercial establishments to search for alternatives that allow them to deal with price dynamism in the most practical, economical, fast, and efficient way possible.

Likewise, the presentation of prices must be made in the clearest way possible, so that consumers identify the prices without possible confusion that causes delays in the purchase of the products. In addition, the correct visualization of the prices also turns out to be relevant as advertising of a product, since the consumer could be motivated to make the purchase, if the displayed price is attractive. Furthermore, the correct visualization of a price from a great distance can favor the selection of a product over another with the same characteristics.

Therefore, most businesses try to standardize the methods they use to display the prices of their products. For example, some commercial establishments use an individual labeling system, in which the prices of the products are printed on small labels that are placed directly on the external surface of the products. Said labels have an adhesive that facilitates their placement safely, and facilitate the collection of products in small establishments, since each product has an associated price that can be viewed by the personnel in charge of collection. However, the use of printed labels is impractical when handling large volumes of merchandise or when products are sold in bulk. Additionally, if it were necessary to change the price of a product, the labels attached to each of its units would have to be removed to be replaced by the updated price, which increases the time required to make the price change. On the other hand, it is also possible to use a price printed in a large format, for example, on a poster, to show the price of a specific product, without resorting to individual labeling, but there is still the inconvenience of having to make new prints on case of wanting to change the price of a product, which also represents the accumulation of significant amounts of waste, since the printed prices are mostly for single use.

Due to the problems related to the use of printed prices, alternatives have been developed that do not require the use of disposable materials, such as pricers, which are devices designed to show alienated numbers that represent the prices of the products sold. Among this type of devices, one can differentiate those that use automated mechanisms to display the numbers and those that have manual mechanisms to do so.

Within the pricers that use automated mechanisms to show prices, there are electronic pricers, which show the prices of the products through arrays of lights that turn on in an orderly manner to show the numbers. Likewise, there are pricers with LCD screens or similar, which are reproduced from a distribution system to sample recordings with prices. However, even though this type of electronic equipment can avoid the generation of waste and facilitate rapid price changes, they have the disadvantage of requiring electrical power sources, which is why they necessarily require the presence of an electrical infrastructure available in the areas where they will be placed, which limits their use in shelves that do not have access to the electrical network.

As an alternative to the use of printed prices and electronic pricers, manual pricers have been developed, which can be divided into those that use interchangeable characters and those that use mechanical systems based on roll-up structures that support printed bands in which the price numbers are shown. In the case of pricers with interchangeable characters, the price change operation turns out to be slow, since the numbers to be displayed must be selected individually, which means that the people in charge of changing prices have to invest a lot of time in said activity, with which its productivity decreases. Also, because the numbers are loose, they can be lost or damaged by constant handling. Therefore, although the pricers with interchangeable characters can be a useful option, they are not very suitable to be used on a large scale, since they tend to deteriorate quickly due to the continuous manipulation of their components and, in addition, they require considerable time for their manipulation.

In the case of mechanical pricers that use roll-up structures, their operation is simpler since to make changes in prices, it is only necessary to wind or unwind the band that contains the printed numbers, which makes them less prone to failures. This type of device is described, for example, in the patent application DE2241631A1, which refers to a device for displaying various information by means of tapes that are received on rollers that can rotate in both directions. Said device also has a light source that improves the visualization of the information, which is located behind the band that displays the information. The aforementioned device allows different types of information to be displayed, but it uses a coordinated movement mechanism, so only one element can be sampled at a time, which would be impractical in case of wanting to vary only particular figures of a price.

Utility Model CN 87207184 U describes a pricer designed to change prices by rolling up a band horizontally. Said device is designed to be placed on flat surfaces and does not have elements that allow it to be fixed to a shelf. Furthermore, the above mentioned Utility Model pricer can only show one price at a time, and it does not allow changes to only some of its figures.

Application WO1987007745A1 describes equipment for displaying numerical information, consisting of a plurality of motorized rollers that allow the figures of a price to be changed individually, so that individual changes can be made for each of the figures. However, since motors are used to change the numbers, an external power source is needed to be able to make the price changes, which limits the use of the pricer only to places with installed power lines.

Finally, Application DE3237327 A1 describes a pricer that is remotely controlled to change prices. In order to be able to change the prices in the pricer of the afore mentioned Application, a signal is sent from an external control to a receiving unit, to activate a plurality of motors, each one of which moves a set of coordinated axes that support a band with numbers, so that each of the figures of the prices displayed can be actively modified. However, because the equipment uses electric motors, a constant supply of electrical power is required to operate the pricer.

Although the developments described above and those available in the market represent alternatives to show the prices of the products and make the change of the same, the generation of large amounts of waste, the accelerated wear suffered by the numerical parts due to the constant manipulation in their selection and replacement, the need for energy sources to be able to be used and the additional and constant cost that energy consumption represents, continue to be disadvantages that need to be eliminated.

In view of the above problems, there is a need to provide a manual pricer that allows the number to be changed independently, by means of adequate mechanisms to avoid clogging problems. Also, there is a need to provide a pricer with structures that prevent damage to its internal mechanisms and preferably protect its mechanisms for number selection. In addition, there is a need to provide a pricer that is protected against unauthorized tampering with its number selection mechanism, to prevent unauthorized price changes.

Additionally, there is a need to provide a pricer that can be placed on any type of conventional surface or shelf, without it being necessary to modify said surface or shelf, and which also has structures to support headpieces with product information or advertising information, to avoid the use of structures attached to the pricer that must be placed on the surface or on the shelf where the products are displayed.

### SUMMARY OF THE INVENTION

In order to overcome the drawbacks of the existing pricers, the present invention aims to provide a manual mechanical pricer, which allows the price numbers to be changed independently, by means of a mechanism of pulleys coordinated with pulleys that does not suffer clogging

A particular objective of the present invention is to provide a pricer with a structure that protects the pulley mechanism that is used to change the prices, to avoid impact damages or unauthorized tampering.

Another objective of the present invention is to provide a pricer with structures that allow it to be placed on any type of surface or conventional shelf, without the need to make modifications to them.

An additional objective of the present invention is to provide a pricer with structures that allow it to support headpieces with product information and/or advertising information, in such a way that it is not necessary to place additional structures on the surface or shelf where it is used.

The foregoing, as well as other objects and advantages of the present invention will become apparent from the following detailed description thereof.

### DESCRIPTION OF THE FIGURES OF THE INVENTION

FIG. 1 shows a pair of perspective views of the pricer of the present invention.

FIG. 2 shows a rear perspective view of a front section (b) of the casing (1) of the pricer of the present invention.

FIG. 3 shows a rear perspective view of the sections (a) of the casing (1) of the pricer of the present invention.

FIG. 4 shows the sections (a) of the casing (1) before being joined together.

FIG. 5 shows a perspective view of the lower cover (114) of the pricer of the present invention.

FIG. 6 shows a perspective view of the pricer of the present invention with the lower cover (114) half open.

FIG. 7 shows the pricer of the present invention, in which two separable bases (S) placed in the lower part of the pricer with straight bases (120) can be observed.

FIG. 8 shows the pricer of the present invention, in which a separable base (S) placed in the lower part of the pricer, with a pedestal (121) is observed.

FIG. 9 shows the pricer with headpieces attached to it.

FIG. 10 shows the pricer of the present invention hung from the central perforations (104) of the profiles for headpieces (103).

FIG. 11 shows the pricer of the present invention, placed on a product tray.

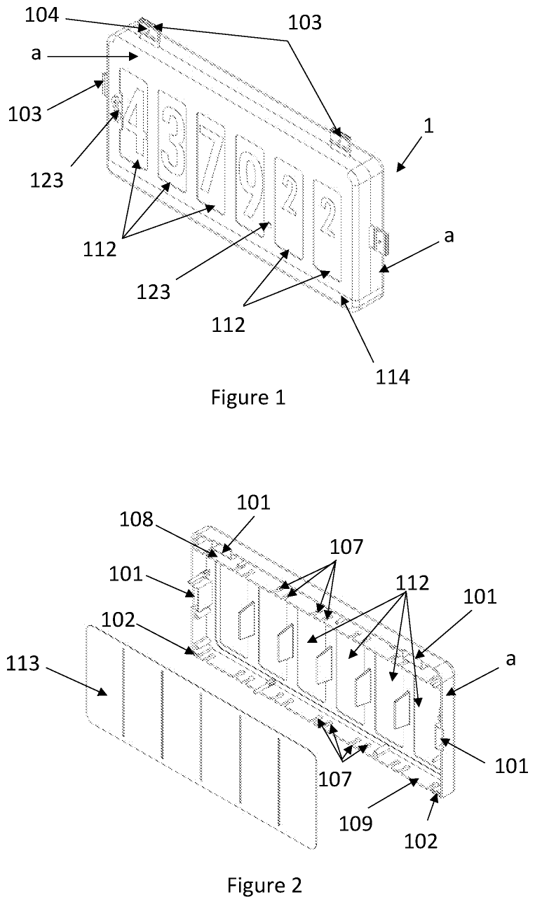

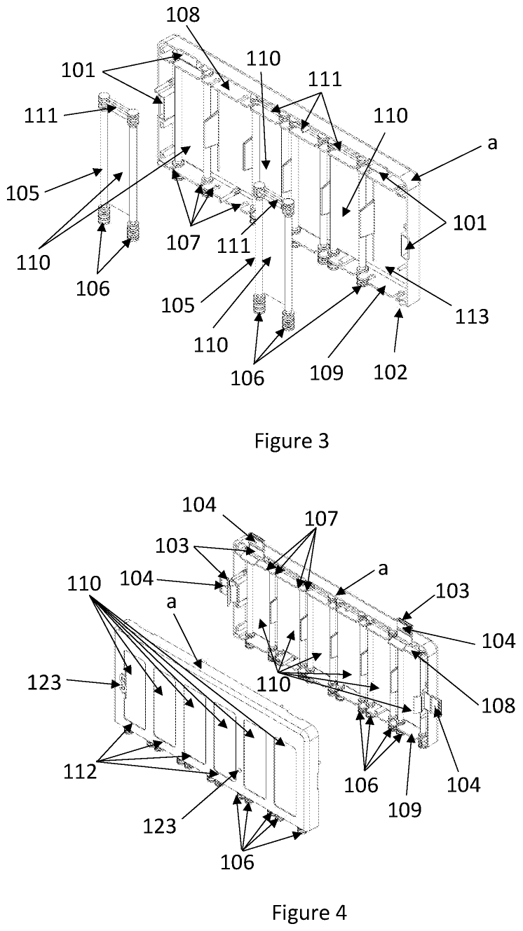

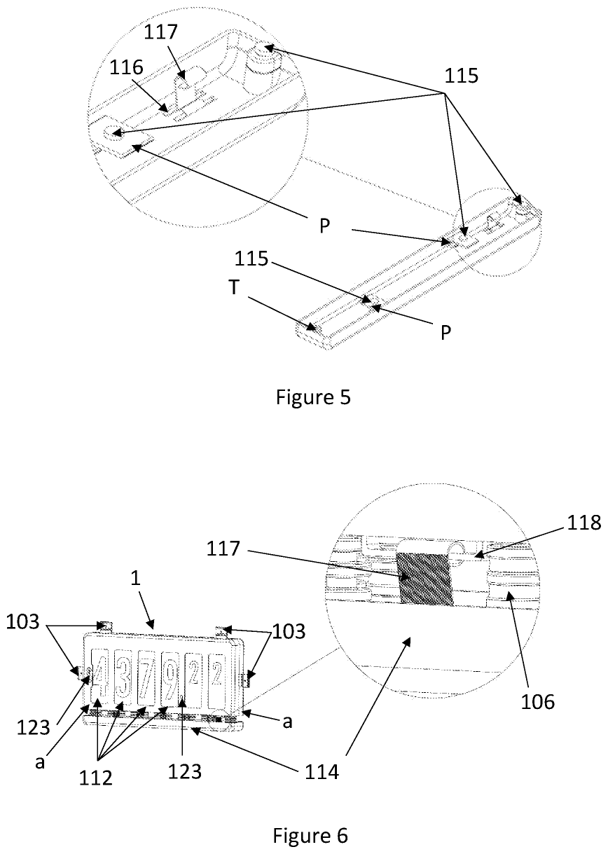

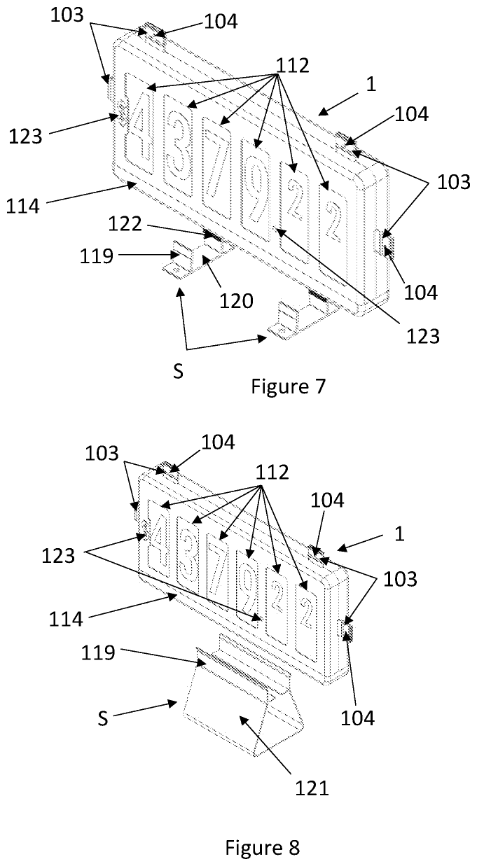

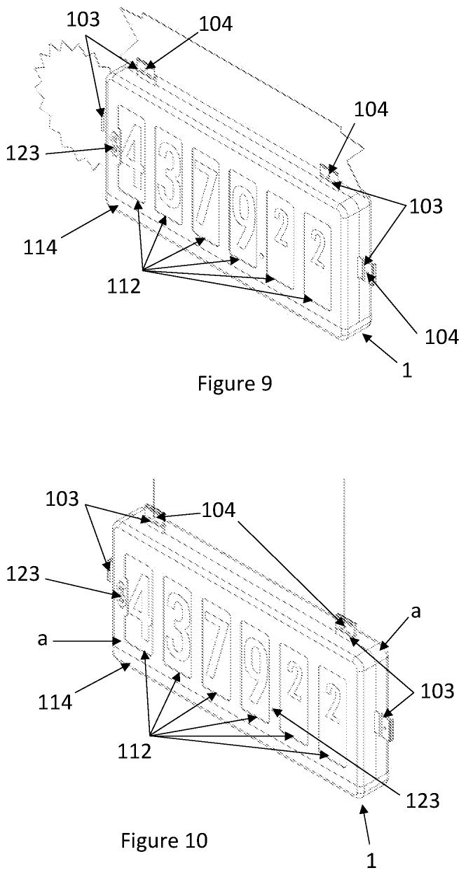

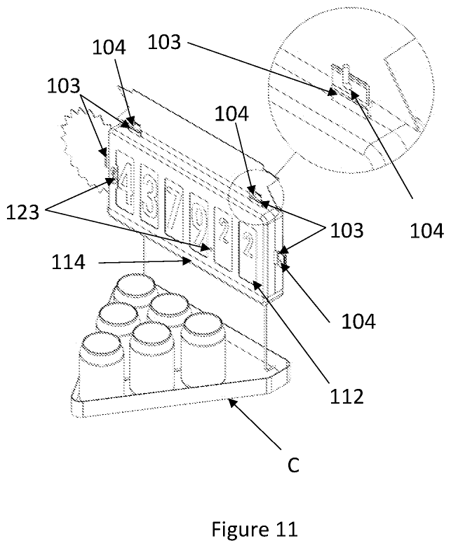

### DETAILED DESCRIPTION OF THE INVENTION

The present invention provides a manual mechanical pricer, which uses a plurality of bands printed with numbers, used to represent the price of traded items, which are coupled to a pulley mechanism that controls the independent rotation of each of the printed bands, so a quick and easy change between different prices can be made. In addition, the manual mechanical pricer of the present invention is designed to protect the pulley mechanism from shocks caused by collisions with traded items or from unauthorized manipulation.

Additionally, the present invention provides a manual mechanical pricer, which has structures that facilitate its placement on different surfaces, so it can be arranged on any type of conventional shelf, without the need to make modifications to the pricer or to the surfaces or shelves where it will be placed. Likewise, the present invention provides a manual mechanical pricer, which is designed to be able to support informative posters on it, in such a way that it is adapted to support headpieces with advertising information and/or information about the product whose price is shown.

The manual mechanical pricer of the present invention is made up of a casing (1) preferably in the shape of a parallelepiped, made up of a pair of sections (a), which have on their perimeter a plurality of receiving cavities (101) that correspond to each other, in such a way that when joining said sections (a) of the casing (1), some receptacles are formed between them, in which some profiles for headpiece (103) with central perforations (104) are placed, said profiles for headpieces being (103) adapted for placing advertising headpieces and/or with product information, and/or for receiving structures for hanging such as hooks, cables or tubular profiles; a pulley mechanism made up of a plurality of axes (105) with terminal pulleys (106), which are held and rotatably received in rotation cavities (107) that are arranged in an upper projection (108) and in a lower projection (109), located in the internal part of each of the pair of sections (a) of the casing (1), the pulleys (106) being arranged in the lower part of the axes (105), preferably covered by a cylinder of hot-shrinking material; a plurality of printed bands (110), which are fixed between two axes (105) adjacent to each other, said axes (105) having adjacent to each other, bands (111) arranged between the terminal pulleys (106) of their upper ends, to coordinate the rotary movement of said axes (105), in such a way that by manually rotating one of the lower pulleys in one direction, the printed band (110) supported between the axes (105) is wound in the same direction of the turn of the pulley, thus showing different numbers; four magnets (102), arranged in the lower part of the casing (1), two of which are arranged at the ends of the casing (1), housed in lower cavities formed by the union of recesses in one of the sections (a) with corresponding recesses in the other section (a), while the other two are arranged on the outside of the lower face of each of the sections (a), respectively, said two magnets being on the outside of the lower faces of sections (a), equidistant from the magnets (102) housed in the ends of the casing (1); a plurality of viewing windows (112) arranged on the larger surface of each of the pair of sections (a), which are covered by a transparent film (113) arranged on the inside of each of the pair of sections (a), in such a way that when joining the pair of sections (a), each of the viewing windows (112) faces one of the printed bands (110) allowing viewing from the outside of both sides of the casing (1); and a lower cover (114) arranged in the lower part of the casing (1), said lower cover (114) being fixed by hinges to one of the sections (a). Said lower cover (114) has an automatic closing mechanism made up of four magnets (115), two arranged at the ends of said lower cover (114) fixed by covers (T) and two placed in a pair of profiles (P) arranged on its inner surface, in positions that correspond to those of the magnets (102) of the casing (1); and a retractable device (117), which is preferably a spring mechanism or an elastic band, which is fixed at one end to a pair of slots (116) arranged in the lower cover (114), while its other end is fixed to a projection (118) arranged in the lower part of the casing (1), in such a way that said retractable device (117) forces the closing of the lower cover (114) to hide the pulley mechanism, being fixed said lower cover (114) in place, by the force of attraction between the magnets (102) and the magnets (115).

Additionally, said cover (114) has a locking mechanism, such as one operated by a key or code, arranged in the internal part of one of the sides of the cover (114), to ensure authorized access to the pulley mechanism only through the key or code.

The manual mechanical pricer of the present invention additionally has at least one separable base (S) to be placed directly on a flat surface. Said separable base (S) is placed in the lower part of the pricer by means of two perpendicular extended profiles (119) that are separated from each other by a distance equal to the width of the casing (1), said two extended profiles (119) joined by a straight base (120) with a width that is greater than the width of the casing (1) or by a pedestal (121) with two surfaces at angle joined diagonally to the extended profiles (119), in such a way that a support is formed that can hold the pricer on a flat surface either almost level with it or elevated above it. Said at least one separable base (S) preferably has a pair of friction bands (122) arranged on the internal face of the extended profiles (119), to improve the tightening against the casing (1). Additionally, the manual mechanical pricer of the present invention may comprise a product tray (C), which has a pair of perpendicular supports that protrude from the surface of said product tray (C), with ends adapted to be received in the central perforations (104) of the profiles for the headpiece (103) of the casing (1), in such a way that the pricer of the present invention can be placed suspended above the items that are stored in said product tray (C).

Preferably, the pricer of the present invention also has a pair of signs (123) that contain symbols such as a sign with the type of currency used, points and commas, which are used to modify the price reading. Said signs (123) have means to be fixed in a removable way on the front part of the pricer around the viewing windows (112), said fixing means being selected from the group consisting of adhesives, suction cups, Velcro and/or magnets. Preferably, said signs (123) are neodymium magnets in the shape of the symbol that will be used, which are fixed to the casing (1) by magnetic attraction caused by a plurality of magnets placed inside said casing (1).

The present invention has been described in accordance with the preferred embodiments thereof; however, it will be apparent to a technician with average knowledge in the matter, that modifications may be made to it, without departing from its spirit and scope.

1. A manual mechanical pricer having printed bands that show numbers, wherein said manual mechanical pricer comprises:
a casing (1) with a pair of sections (a), a plurality of receiving cavities (101) that correspond to each other, arranged on the perimeter of said pair of sections (a), in such a way that when joining said sections (a) of the casing (1), some receptacles are formed between them in which some profiles are placed for the headpiece (103) for the placement of advertising headpieces and/or with product information;
A pulley mechanism comprising a plurality of axes (105) with terminal pulleys (106) that are held and rotatably received in rotation cavities (107) that are arranged in an upper projection (108) and in a lower projection (109), said upper (108) and lower (109) projections being located in the internal part of each one of the pair of sections (a) of the casing (1); a plurality of printed bands (110), which are fixed by their ends between two axes (105) adjacent to each other, said two axes (105) adjacent to each other, having a band (111) that it is arranged at its upper ends, between the terminal pulleys (106), to coordinate the rotary movement of said axes (105), in such a way that by manually rotating one of the lower pulleys in one direction, the printed band (110) supported between the axes (105) is wound up in the same sense of rotation of the pulley, thus showing different numbers;
four magnets (102), arranged in the lower part of the casing (1);
a plurality of viewing windows (112) arranged on the larger surface of each of the sections (a), which are covered by a transparent film (113) arranged on the inside of each of the sections (a) of the casing (1), in such a way that when joining said sections (a) of the casing (1), each of the viewing windows (112) faces one of the printed bands (110) allowing the viewing of the respective printed band from both sides of the exterior of the casing (1);
a lower cover (114) arranged in the lower part of the casing (1) and fixed by hinges to one of the sections (a) of the casing (1), said lower cover (114) having four magnets (115), arranged in positions that correspond to those of the magnets (102) of the casing (1); and
an automatic closing mechanism having a retractable device (117) fixed by one of its ends in a pair of slots (116) arranged in the lower cover (114), while its other end is fixed to a protrusion (118) arranged in the lower part of the casing (1), in such a way that said retractable device (117) forces the closure of the lower cover (114) to hide the pulley mechanism, said lower cover (114) being fixed in its place, by the force of attraction between the magnets (102) and the magnets (115).

2. The pricer according to claim 1, wherein said manual mechanical pricer further comprises a locking mechanism operated by a key or code, arranged in the internal part of one of the sides of the cover (114).

3. The pricer according to claim 1, wherein said manual mechanical pricer comprises the pulleys (106) arranged in the lower part of the axes (105) are covered by a cylinder of hot-shrinking material.

4. The pricer according to claim 1, wherein said manual mechanical pricer the profiles for the headpiece (103) have central perforations (104) for receiving structures for hanging such as hooks, cables or tubular profiles.

5. The pricer according to claim 1, wherein said manual mechanical pricer two of the magnets (102) are arranged at the ends of the casing (1) and are housed in lower cavities formed by the union of recesses at the ends of the sections (a) of the casing (1), while the other two magnets (102) are arranged on the outside of the lower face of each of the sections (a), respectively, said two magnets of the outside of the lower faces of the sections (a), being equidistant from the magnets (102) housed in the ends of the casing (1).

6. The pricer according to claim 5, wherein said manual mechanical pricer two of the magnets (115) are arranged at the ends of the lower cover (114) fixed by covers (T), while the other two magnets (115) are placed in a pair of profiles (P) arranged on the inner surface of the lower cover (114).

7. The pricer according to claim 1, wherein said manual mechanical pricer further comprises at least one separable base (S) that is placed in the lower part of the pricer by means of two perpendicular extended profiles (119) that are separated from each other by a distance equal to the width of the casing (1).

8. The pricer according to claim 7, wherein said manual mechanical pricer comprises at least one separable base (S) comprises two extended profiles (119), joined by a straight base (120) with a width that is greater than the width of the casing (1) or by a pedestal (121) with two surfaces at angle joined diagonally to the extended profiles (119), in such a way that a support is formed that can hold the pricer on a flat surface either at the same level as the same or elevated above it.

9. The pricer according to claim 8, wherein said manual mechanical pricer comprises at least one separable base (S) preferably has a pair of friction bands (122) arranged on the internal face of the extended profiles (119), to improve the tighten against the casing (1).

10. A manual mechanical pricer according to claim 1, wherein said manual mechanical pricer comprises a pair of signs (123) containing symbols, said signs (123) having means to be fixed in a removable manner on the front part of the pricer around the viewing windows (112).

11. The manual mechanical pricer according to claim 10, wherein the means for fixing the signs (123) are selected from the group consisting of adhesives, suction cups, Velcro and/or magnets.

12. The pricer according to claim 1, wherein said manual mechanical pricer also comprises a product tray (C) that has a pair of perpendicular supports that protrude from the surface of said product tray (C), with ends adapted to be received in the central perforations (104) of the profiles for the headpiece (103) of the casing (1).
